(19) United States
(12) Patent Application Publication
(10) Pub. No.: US 2010/0205600 A1
(43) Pub. Date: Aug. 12, 2010

(54) SIMULATION METHOD FOR REALIZING LARGE BATCHES AND DIFFERENT KINDS OF BASEBOARD MANAGEMENT CONTROLLERS USING A SINGLE SERVER

(75) Inventors: Guo-Hong TU, Tianjin (CN); Jin-Cheng LIU, Tianjin (CN); Tom CHEN, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/366,834

(22) Filed: Feb. 6, 2009

(51) Int. Cl. G06F 9/455

(52) U.S. Cl. 718/1

(57) ABSTRACT

A simulation method for realizing large batches and different kinds of baseboard management controllers using a single server includes providing a virtual baseboard management controller by a target terminal according to different customized virtual baseboard management controller resources correspondingly. The simulation method includes initializing large batches and different kinds of virtual baseboard controller programs according to a customizable virtual baseboard controller resource. If a client requests to access one baseboard controller or multiple baseboard controllers, which virtual baseboard controller will provide a service is determined according to the information of the accessing request of the client. Then an output result is generated according to the behaviors defined in the customized resource. Finally, the output result is transferred to the client. Therein, the client may connect to the target terminal through Internet or a bus.

### BACKGROUND OF THE INVENTION

1. Field of Invention

The present invention relates to a method for simulating different kinds of baseboard management controllers in batches, and more particularly to a simulation method for realizing large batches and different kinds of baseboard management controllers using a single server.

2. Related Art

Intelligent platform management interface (IPMI) enables system managers to monitor health conditions of various elements in a computer device by networks, standard serial ports, or other transmitting means. For example, such health conditions include the operation of a central processing unit, the rotating speed of a heat sink fan, the temperature and voltage of a chip in a motherboard, and the like. System managers may set the sensing thresholds of the parts to be monitored, and send a PET (a derivative of SNMP trap) to MIS personnel to notify them to address a problem when the IPMI controller cannot sense normal conditions. Additionally, with the cooperation of hardware and software, the IPMI is added with a remote management function and a system reply function. As such, system managers at a remote place may know what condition the system is currently in, such as power down, power on, or OS shutdown, and send a command, such as power on, power down, and reboot.

FIG. 1 is a schematic view of the architecture of an IPMI and a baseboard management controller in the prior art. Referring to FIG. 1, with a baseboard management controller (BMC) 120, a remote device 110 may be enabled to monitor the hardware health condition of a server. The BMC 120 may poll a digital sensor periodically to monitor the current working status of a server hardware 130, make a record in time when a problem is found, and adopt corresponding protective measures. In other words, the BMC 120 may be considered as a separate operation and control unit. Therefore, the BMC 120 must be provided with separate firmware to enable relevant functions of the BMC 120. However, whether a remote device can manage large batches and different kinds of physical BMCs correctly is an intractable problem. We cannot exhaust all of the physical BMCs to verify whether the remote device is managing the BMCs according to the IPMI specification. Moreover, we cannot use hundreds of physical BMCs to verify whether the remote device has the ability of management.

United States Patent Publication US20060184349A1 disclosed an implementation of a virtual blade server. That implementation mentioned that a conceptual baseboard controller was provided on each virtual blade, and it did not provide an implementation that can realize the customization of different kinds of baseboard controller resources and the real time control of the condition and behavior of the baseboard controllers. Furthermore, that method cannot analogy a large number of BMCs.

### SUMMARY OF THE INVENTION

In view of the above problems, the present invention is mainly directed to a simulation method for realizing large batches and different kinds of BMCs using a single server. A target terminal provides a virtual BMC according to a customizable BMC resource correspondingly, thereby realizing a test platform that can verify whether a remote device is accorded with the IPMI specification. The remote terminal may also send a control command to perform real time control and change the behavior of a baseboard controller. And the performance of the remote device accessing a large number of baseboard controllers at the same time may be verified.

For this purpose, the present invention provides a method for operating by virtual BMCs. The method includes the following steps. Various virtual baseboard controller programs are initialized according to a customizable BMC resource correspondingly. Once an access request from a client is received, the relevant data of the corresponding virtual baseboard controller is obtained with the requested and relevant information carried in the access request as an index. The virtual baseboard controller generates an output result according to a rule defined in the customizable resource. Finally, the output result is returned to the client.

The present invention provides a test platform, which simulates BMCs in batches to verify the IPMI specification of a remote device. Users may customize various virtual BMCs conveniently and simulate large batches of virtual BMCs. Various different virtual BMCs are initialized according to the user profiles, and which virtual baseboard controller will be used to enable the operation of a client is determined according to the requested and relevant information carried in an access request of the client. In this way, vendors may reduce the cost and space of the hardware setup related to buying large batches and different kinds of virtual BMCs, and may efficiently provide different BMCs to test for a client.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the architecture of an IPMI and a baseboard management controller in the prior art.

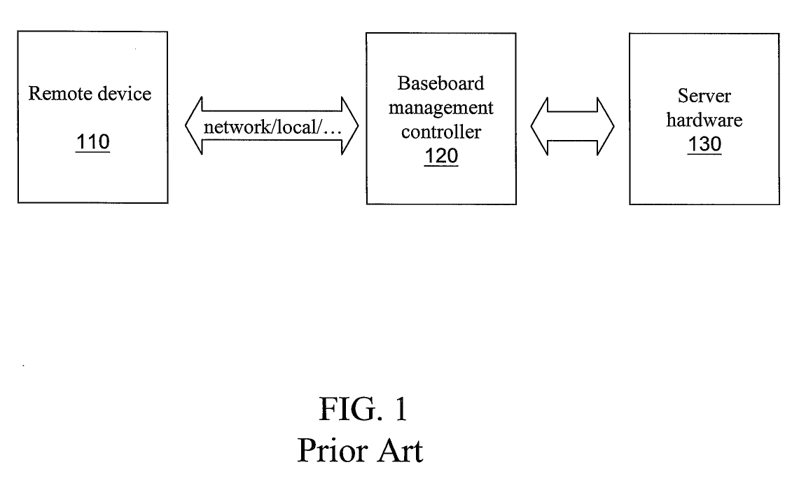

FIG. 2A is a schematic view of the architecture according to the present invention.

FIG. 2B is a schematic view of the management of a virtual baseboard controller management program.

FIG. 3 is a schematic view of the operation flow according to the present invention.

FIG. 4 is a schematic view of the operation flow through a network connection test according to the present invention.

FIG. 5 is a schematic view of the operation flow of the connection test at the target terminal according to the invention.

FIG. 6 is a schematic view of the overall architecture according to the present invention.

### DETAILED DESCRIPTION OF THE INVENTION

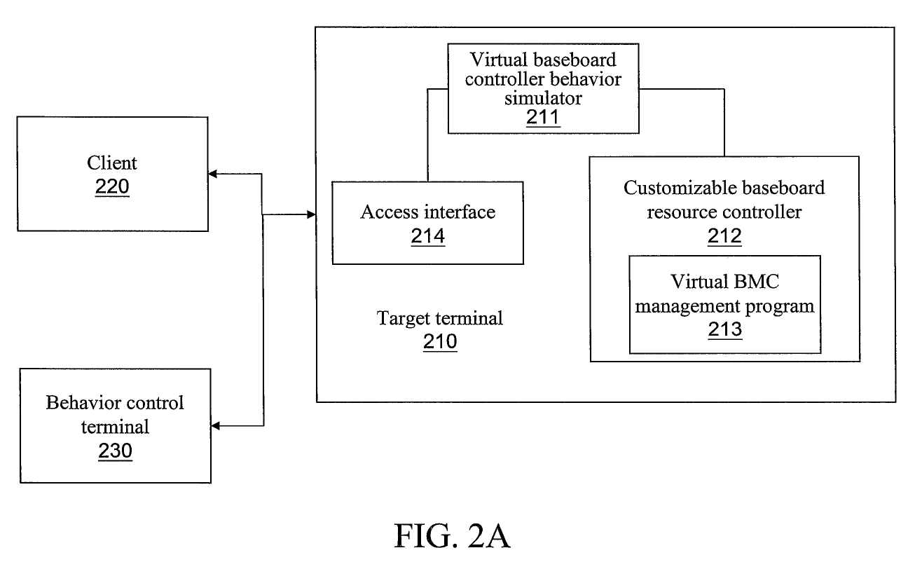

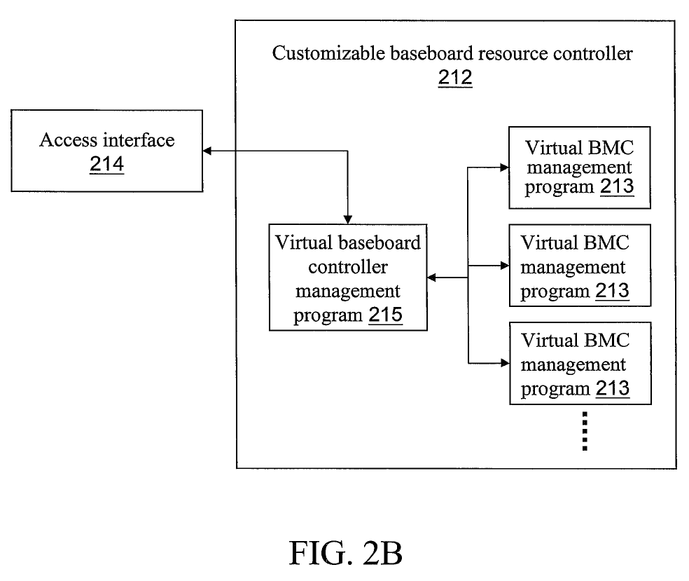

FIG. 2A is a schematic view of the architecture according to the present invention. Referring to FIG. 2A, the architecture includes a target terminal 210 and at least one client 220. The target terminal 210 is electrically connected to the client 220. Electrical connection includes Internet connections, buses, serial lines, and the like. In the present invention, the client 220 is a physical apparatus of a remote device, and may use a behavior control terminal 230 to send a control command to the target terminal 210, in order to change or control the behavior of a virtual baseboard controller in real time. The target terminal 210 includes a virtual baseboard controller behavior simulator 211, a customizable baseboard resource controller 212, a virtual BMC management program 213 and an access interface 214. The customizable baseboard resource controller 212 is used to store the virtual BMC management program 213. The virtual baseboard controller behavior simulator 211 is electrically connected to the customizable baseboard resource controller 212 and the access interface 214 respectively. The virtual baseboard controller behavior simulator 211 is used to execute the virtual BMC management program 213. Through the access interface 214, the virtual baseboard controller behavior simulator 211 is connected to the client 220 or accesses various peripheral devices in the target terminal 210.

The present invention further includes a virtual baseboard controller management program 215. The virtual baseboard controller management program 215 is connected to a client and invokes the virtual BMC management program 213 that is accorded with the client. FIG. 2B is a schematic view of the management of a virtual baseboard controller management program. Referring to FIG. 2B, the virtual baseboard controller management program 215 is connected to the access interface 214. If connected to different clients, the virtual baseboard controller management program 215 may invoke corresponding virtual BMC management program 213.

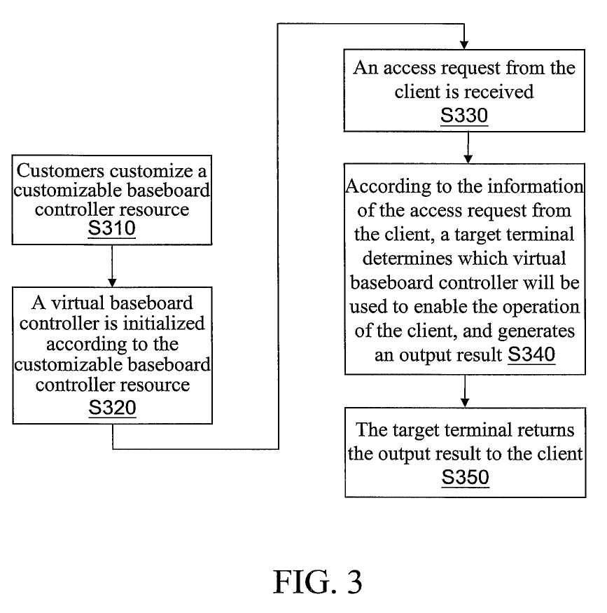

FIG. 3 is a schematic view of the operation flow according to the present invention. Referring to FIG. 3, the execution of the virtual baseboard control procedure according to the present invention includes the following steps. First, customers customize a customizable baseboard controller resource (Step S310). Then a virtual baseboard controller is initialized according to the customizable baseboard controller resource (Step S320), and an access request from the client is received (Step S330). Therein, the environmental parameters of the virtual baseboard controller are determined according to the customizable baseboard controller resource. According to the information of the access request from the client, a target terminal determines which virtual baseboard controller will be used to enable the operation of the client, and generates an output result (Step S340). Finally, the target terminal returns the output result to the client (Step S350).

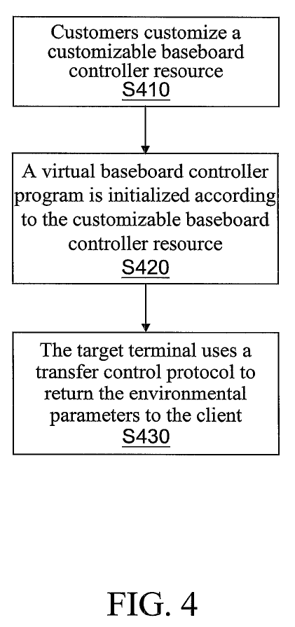

FIG. 4 is a schematic view of the operation flow through a network connection test according to the present invention. Referring to FIG. 4, receiving the request information further includes the following steps.

Customers customize a customizable baseboard controller resource (Step S410), wherein the customizable baseboard controller resource is the environmental data required by the baseboard controller to operate, (e.g., how many customers the baseboard controller involves, the sensor data record information, the Internet Protocol address (IP address) of the baseboard controller), the number of baseboard controllers of the same type to be simulated, the rule of the behavior characteristics of a virtual baseboard controller, and the like. Then, a virtual baseboard controller program is initialized according to the customizable baseboard controller resource (Step S420). According to the information of the access request from the client, it is determined that which virtual baseboard controller will be used to enable the operation of the client. For each client 220, the target terminal 210 uses the information of the access request, such as the IP Address, to assign different virtual BMC management programs 213 for corresponding process.

Then, the target terminal uses a transfer control protocol to return the environmental parameters to the client (Step S430). In order to send the environmental parameters to the client 220 indeed, the present invention utilizes the transfer control protocol as a communication protocol between the target terminal and the client, thereby ensuring the messages transferred by them will not be lost.

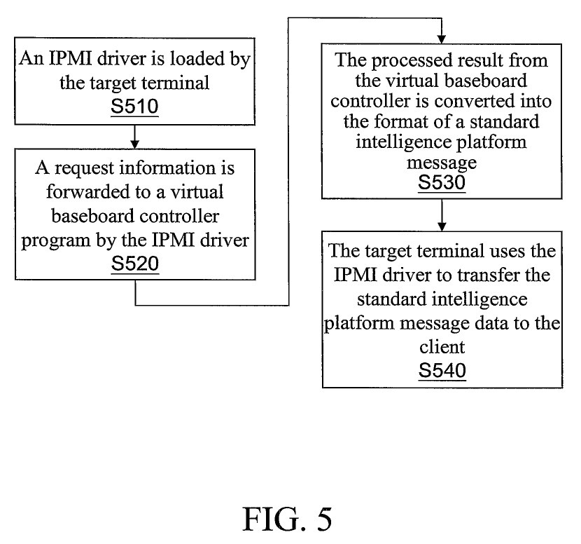

FIG. 5 is a schematic view of the operation flow of the connection test at the target terminal according to the invention. Referring to FIG. 5, in another aspect of the present invention, the client 220 is connected to the target terminal 210 directly. Such an embodiment includes the following steps.

First, the target terminal initializes a virtual baseboard controller according to a customizable baseboard controller resource, and loads an IPMI driver (Step S510). As the client 220 is electrically connected to the target terminal 210 through a bus, the target terminal 210 may invoke the IPMI driver to communicate with the client 220. It should be noted that, the number of buses is limited, so the target terminal 210 may be connected to only one client 220 to do test in such an embodiment.

Next, a request information is forwarded to a virtual baseboard controller program by the IPMI driver (Step S520). The target terminal 210 invokes the IPMI driver to receive messages from the client 220 or send messages to the client 220, so the transmission time is shorter than that in the first embodiment.

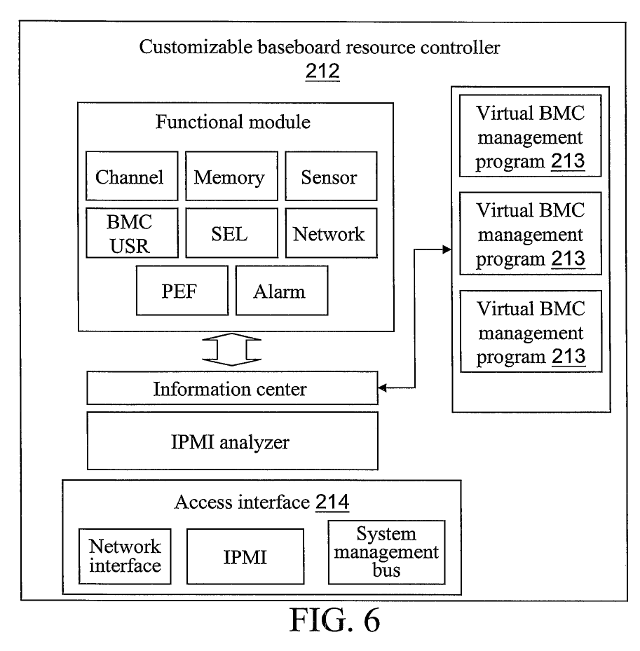

When the virtual baseboard controller program replies a request result, the processed result from the virtual baseboard controller is converted into the format of a standard intelligence platform message (Step S530), and a corresponding function in a functional module is invoked according to the request from the client. Therein, the functional module manages the functions such as channels, memories, sensors, baseboard controller customers (BMC USR), system event logs (SEL), network, platform event filter (PEF), and alarms. Finally, the target terminal uses the IPMI driver to transfer the standard intelligence platform message data to the client (Step S540). In order to further illustrate the operation of the steps described above, refer to FIG. 6 now. FIG. 6 is a schematic view of the overall architecture according to the present invention.

The present invention is directed to a virtual BMC. A target terminal 210 connected to one or more clients 220 is used to make connection with the virtual BMC. A BMC is initialized according to a customizable baseboard controller resource correspondingly. Then the target terminal 210 invokes different BMCs according to an access request information from the client 220 to enable the operation and test of the client 220. In this way, vendors may reduce the cost and space of the hardware setup of the client 220, and efficiently provide different BMCs to serve the client 220.

What is claimed is:

1. A simulation method for realizing large batches and different kinds of baseboard management controller (BMC) using a single server, a target terminal uses different customized virtual BMC resources to provide corresponding virtual BMC to a client, the simulation method comprising:
customizing a resource of a customizable baseboard controller;
initializing a virtual baseboard controller according to the resource of the customizable baseboard controller; and
enabling the operation of the corresponding virtual baseboard controller according to an access request information of the client, generating an output result, and returning it to the client.

2. The simulation method for realizing large batches and different kinds of BMC using a single server according to claim 1, further comprising a virtual baseboard controller management program, the virtual baseboard controller management program accorded with the client connected to it is invoked according to the access request information of the client.

3. The simulation method for realizing large batches and different kinds of BMC using a single server according to claim 1, wherein the reception of the request information is connected to the target terminal through the Internet.

4. The simulation method for realizing large batches and different kinds of BMC using a single server according to claim 1, wherein the client is electrically connected to the target terminal through a bus.

5. The simulation method for realizing large batches and different kinds of BMC using a single server according to claim 3, wherein receiving the request information further comprising:
loading an intelligent platform management interface driver by the target terminal;
forwarding the request information to the virtual baseboard controller management program through the IPMI driver; and
if an environmental parameter is returned by the virtual baseboard controller management program, the environmental parameter is returned to the client through the IPMI driver.
